(19) United States
(12) Patent Application Publication
(10) Pub. No.: US 2011/0154014 A1
(43) Pub. Date: Jun. 23, 2011

(54) DATA EXCHANGE FOR MOBILE DEVICES

(75) Inventor: Ola Karl Thôrn, Malmo (SE)

(73) Assignee: SONY ERICSSON MOBILE COMMUNICATIONS AB, Lund (SE)

(21) Appl. No.: 12/641,361

(22) Filed: Dec. 18, 2009

(51) Int. Cl. H04L 29/06; H04B 17/00; G06F 17/30; G06F 3/01; G06F 15/16

(52) U.S. Cl. 713/150; 455/67.7; 707/705; 715/748; 709/225

(57) ABSTRACT

A method may include identifying a selected file recipient device based on a location of the file recipient device, a location of a file transmitting device, and an orientation of a file transmitting device. A file transfer request may be transmitted to the selected file recipient device. An acknowledgement may be received from the selected file recipient device based on the orientation of the selected file recipient device being approximately 180 degrees offset from the orientation of the file transmitting device. A selected file may be transmitted to the file recipient device following receipt of the acknowledgement.

### BACKGROUND

As growth in the use of mobile devices continues, the amount of information stored on such devices also increases. Accordingly, the ability to easy and quickly transfer files and other information between mobile devices has become more and more important.

### SUMMARY

In one embodiment, a method is provided. The method may include identifying a selected file recipient device based on a location of the file recipient device, a location of a file transmitting device, and an orientation of a file transmitting device; transmitting a file transfer request to the selected file recipient device; receiving an acknowledgement from the selected file recipient device based on the orientation of the selected file recipient device being approximately 180 degrees offset from the file transmitting device; and transmitting a selected file to the file recipient device following receipt of the acknowledgement.

Additionally, the identifying the selected file recipient device may include identifying a number of available file recipient devices; determining, a geographic locations of the number of available file recipient devices; determining the orientation of the file transmitting device; determining a geographic location of the file transmitting device; and identifying the selected file recipient device based on the geographic locations of the number of available file recipient devices, the geographic location of a file transmitting device, and an orientation of the file transmitting device.

Additionally, the method may include generating a pointing line based on the geographic location and the orientation of the file transmitting device; determining whether at least one of the number of available file recipient devices is within a predetermined distance of a location on the pointing line based on the geographic locations of the number of available file recipient devices; and identifying the selected file recipient device when the selected file recipient device is within the predetermined distance of the location on the pointing line.

Additionally, the method may include identifying the selected file recipient device as the closest of a second number of available file recipient devices located within the predetermined distance of the pointing line.

Additionally, the predetermined distance of the location on the pointing line may be based on a distance from the file transmitting device.

Additionally, the predetermined distance of the location on the pointing line may be based on a tolerance value associated with locations on the pointing line.

Additionally, the file transfer request may include the orientation of the file transmitting device.

Additionally, the acknowledgement may include the orientation of the file recipient device.

Additionally, transmitting the selected file to the file recipient device may include comparing the orientation of the file recipient device with the orientation of the file transmitting device; and transmitting the selected file to the file recipient device when the orientation of the file recipient device substantially matches an angle 180 degrees offset from the orientation of the file transmitting device.

Additionally, the method may include encrypting the selected filed based on the orientation of the file recipient device, wherein the selected file is decrypted by the file recipient device based on the orientation of the file recipient device.

Additionally, the method may include generating an audible, visual, or haptic notification at the file transmitting device when the file transmitting device is pointed at one of the number of available file recipient devices.

According to another aspect, a method may include providing identification and geographic location information for a destination device to a source device via a network; receiving a file transfer request that includes a geographic location of the source device; and an orientation of the source device via the network; determining whether an orientation of the destination device substantially matches an angle 180 degrees offset from the source device; transmitting a file transfer acknowledgement to the source device via the network when an orientation of the destination device substantially matches an angle 180 degrees offset from the orientation of the source device; and receiving a selected file from the source device via the network.

Additionally, providing identification and geographic location information for a destination device may include transmitting the identification and geographic location information to a location-aware service.

Additionally, providing identification and geographic location information for a destination device may include transmitting the identification and geographic location information to devices connected to the network, wherein the network comprises a local wireless network.

Additionally, the method may include generating an audible, visual, or haptic notification upon receipt of the file transfer request.

Additionally, the notification may indicate a direction of the source device.

Additionally, the file transfer acknowledgement may include the orientation of the destination device.

Additionally, the selected file may include an encrypted file, and the method may further include decrypting the selected file based on the orientation of the destination device.

A mobile device may include a communication interface to receive geographic location and identification information associated with a number of destination devices via a computer network; a location-determining device to determine a geographic location of the mobile device; an orientation-determining device to determine an orientation of the mobile device; and a processor. The processor may be configured to receive a user selection of a file; identify a selected destination device from the number of destination devices based on the geographic location of the destination devices, the location of the mobile device, and the orientation of the mobile device; transmit a file transfer request to the selected destination device via the communication interface; receive an acknowledgement from the selected destination device based on the orientation of the selected destination device being approximately 180 degrees offset from the orientation of the mobile device; and transmit the selected file to the destination device via the communication interface following receipt of the acknowledgement.

Additionally, the processor may be further configured to encrypt the selected file based on the orientation of the selected destination device; and transmit the encrypted file to the selected destination device via the communication interface.

### BRIEF DESCRIPTION OF THE DRAWINGS

The accompanying drawings, which are incorporated in and constitute a part of this specification, illustrate one or more embodiments described herein and, together with the description, explain the embodiments. In the drawings:

FIG. 1 is a block diagram of an exemplary environment for enabling the exchange of files between devices;

FIG. 2 is a diagram of an exemplary device that may implement embodiments described herein;

FIG. 3 is a block diagram of exemplary components of the mobile devices of FIG. 1;

FIG. 4 is a block diagram illustrating one implementation of an exemplary functional block diagram of components implemented in the mobile device of FIG. 3; and

FIG. 5 is a flowchart of an exemplary process for transmitting a file from a source device to a destination device in a manner consistent with implementations described herein.

### DETAILED DESCRIPTION

The following detailed description refers to the accompanying drawings. The same reference numbers in different drawings may identify the same or similar elements.

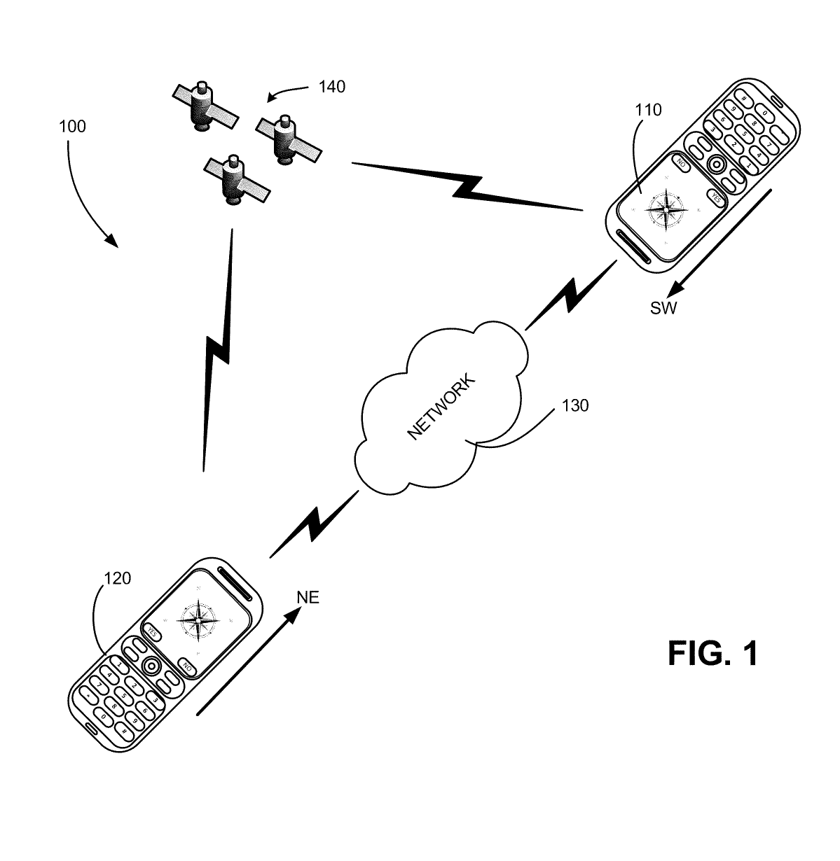

Embodiments disclosed herein may enable users of mobile devices to exchange files or other information by simply pointing their respective devices at each other. FIG. 1 is a diagram of an exemplary environment 100 for enabling the exchange of files (e.g., a photograph, video, music file), streamed data, or other information (e.g., a link, contact information, etc.) via a “point and send” application or interface. As shown, environment may include a mobile device 110, a mobile device 120, a network 130, and location determining devices 140. Network 130 may allow all mobile devices 110 and 120 to communicate with each other.

Each of mobile devices 110 and 120 may include one or more computer systems for hosting programs, databases, and/or applications. Exemplary mobile devices 110/120 may include any suitable device for enabling communication via network 130 and may include a cellular radiotelephone, personal digital assistant (PDA), pager with data communications and/or data processing capabilities, or any device capable of facilitating communication either with another mobile device or with a service provider (not shown) via network 130. For example, mobile devices 110/120 may include a mobile telephone, PDA, gaming device, global positioning system (GPS)-capable device, or other portable device.

Mobile devices 110/120 may communicate with each other directly, or via an access point or wireless router/base station using a wireless communication protocol, e.g., WiFi (e.g., IEEE 802.11x) or WiMAX (e.g., IEEE 802.16x), etc. In other embodiments, mobile devices 110/120 may communicate with other devices using wireless network standards such as GSM (Global System for Mobile Communications), CDMA (Code-Division Multiple Access), WCDMA (Wideband CDMA), GPRS (General Packet Radio Service), EDGE (Enhanced Data Rates for GSM Evolution), etc.

Network 130 may include any suitable wireless network for supporting data exchange between mobile device 110 and mobile device 120. In one implementation, network 130 may include a short-range wireless network, such as a WiFi (e.g., IEEE 802.11x), Bluetooth®, or WiMAX (e.g., IEEE 802.16x) based wireless network. In other implementations, network 130 may include a long-range radio network, such as a CDMA (Code-Division Multiple Access) network, a WCDMA (Wideband CDMA) network, a GSM (Global System for Mobile Communications) network, a GPRS (General Packet Radio Service) network, an EDGE (Enhanced Data Rates for GSM Evolution) network, an HSDPA (high speed downlink packet access) network, etc. In yet other implementations, mobile devices 110/120 may be configured to use multiple types of networks 130, depending on various factors, such as available signal strength, cost, etc. For example, mobile device 110 may be configured to communicate with mobile device 120 via a cellular radio network (e.g., GSM/HSDPA) when mobile device 120 is not connected to a same short-range (e.g., WiFi) network as mobile device 110. When the devices are connected to the same WiFi network, mobile device 110 may communicate with mobile device 120 via the WiFi network.

Location determining devices 140 may include any combination of devices capable of enabling mobile devices 110 and 120 to determine their respective geospatial locations. Examples of location determining devices 140 may include GPS (global positioning system) satellites, cellular towers used in cell-tower triangulation, WiFi (IEEE 802.11x) routers used in location-enabled WiFi services, or transmission towers/antennae used in other radio frequency (RF) distribution technologies (e.g., ultra high frequency (UHF), very high frequency (VHF), etc.).

The GPS system is comprised of 27 GPS satellites (24 active and 3 backups) each configured to orbit the earth twice each day. The positions of the satellites are such that at least four GPS satellites are “visible” in the sky at any one time. Each satellite generates a radio signal that includes time and date, latitude, longitude, and satellite identification information. In order to accurately track a device location in two dimensions (e.g., no altitude or z-direction), signals from at least three satellites should be received, to determine a known location on the Earth's surface using a concept known as 3-D trilateration. In generally, trilateration works because the speed of the satellite signals and their respective locations are known. Accordingly, a time taken for a GPS receiver (e.g., in mobile devices 110/120) to “receive” a signal from each satellite may be used to identify the distance from the satellite to the receiver. Once distances from at least three satellites have been determined, the receiver's location may be determined, since there will be only one point on the Earth's surface that meets each of these distances. For more precise location identification including the receiver's altitude, a fourth satellite signal may be required. It should be understood that signals from more than four satellites may also be received at any one moment, thereby enhancing the performance of the GPS receivers. Additionally, the location of mobile devices 110/120 may be determined by using assisted global positioning system (aGPS), where the assistance data can include ephemeris data, approximate location, time, and other GPS aiding data needed to obtain location quickly or in obstructed line of sight locations (in building, wooded areas, etc.) from the satellites.

Cell tower and WiFi based location determining applications operate in a similar manner to the GPS system described above. However, instead of using signals streamed from satellites, these applications use signals from terrestrial sources, such as cell or RF transmission towers, WiFi routers/access points, etc. Given the known locations of these terrestrial signal sources, locations of connected devices (e.g., mobile devices 110 and 120) may be ascertained with varying degrees of specificity. In an alternative implementation, determining locations of mobile devices 110/120 may involve using a network-based mobile station locator to track and store the geographic location of mobile stations over a given period of time. The stored geographic location information may be obtained from a telecommunications network (e.g., a radio network (not shown)) instead of directly from mobile devices 110/120. Geographic location information may be obtained periodically (based on a predetermined time interval), continuously, or in an “on-demand” basis.

Consistent with implementations described herein, mobile devices 110/120 may include devices and logic components that enable the devices to locate one another based on both a geographic location of the respective devices 110/120 as well as orientations of the respective devices 110/120. For example, assume that Bill, the user of mobile device 110, wishes to send a video file to Susan, a user of mobile device 120. Bill initiates the transfer by selecting the video file in an interface on mobile device 110 and pointing mobile device 110 towards Susan.

As described in more detail below, mobile device 110 may be aware of the geographic location of mobile device 120. For example, each of mobile devices 110/120 may be running location aware applications or services (e.g., Google™ Latitude, etc.) or may be configured to periodically broadcast their locations to other devices connected to network 130. Mobile device 110 may also be aware of its own geographic location, based on geographic location devices 140 describe above.

Mobile device 110 may determine that it is pointing in the northeast (NE) direction to identify mobile device 120 as an intended recipient (based on the known location of mobile device 120). Mobile device 110 may transmit a request to send the video file to mobile device 120.

Susan may be alerted (e.g., visually, audibly, or tactilely) to mobile device 110's request to send the video file. Mobile device 120 may transmit a response to mobile device 110 that includes orientation information indicative of the direction in which mobile device 120 is pointing. Assuming that Susan wishes to receive the offered file, Susan may point mobile device 120 toward Bill, resulting in mobile device 120 having an orientation inverse (e.g., southwest (SW)) to that of mobile device 110. That is, the orientation of mobile device 120 may be 180 degrees offset from that of mobile device 110. If Susan does not wish to receive the offered file, she does not point mobile device 120 at Bill and the orientation of mobile device 120 is not inverse to the orientation of mobile device 110.

When mobile device 110 receives the response from mobile device 120, it determines whether the receive orientation information is inverse (e.g., 180 degrees offset) to it's own determined orientation. If so, mobile device 110 transmits the file to mobile device 120. As described below, the transmitted file may be encrypted using the orientation information, to ensure that only the intended recipient may receive and decrypt the file.

The exemplary configuration illustrated in FIG. 1 is provided for simplicity. In other embodiments, environment 100 may include more, fewer, or different devices. Furthermore, although FIG. 1 shows mobile devices 110/120 coupled to network 130 in a particular configuration, these devices may also be arranged in other configurations, such as through more than one network 130.

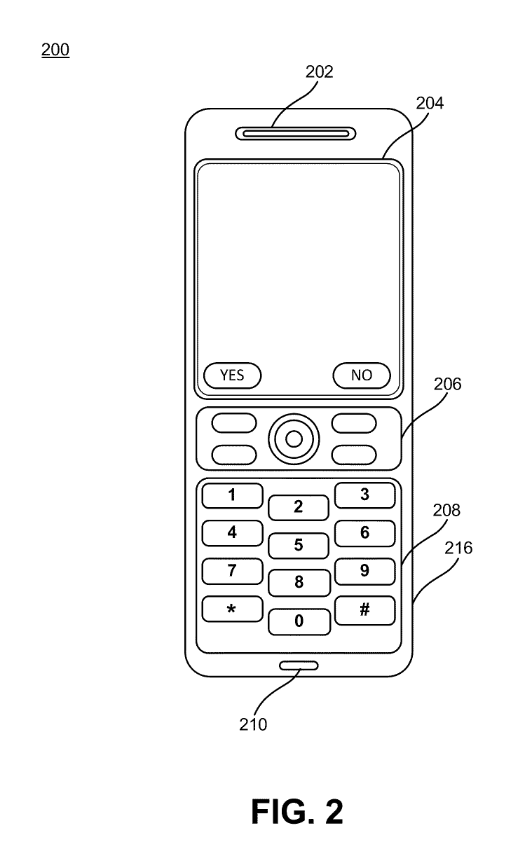

FIG. 2 is a diagram of an exemplary device 200 that may implement embodiments described herein. In one embodiment, mobile devices 110/120 may each correspond to a device such as device 200. Device 200 may include any of the following devices: a mobile telephone; a cellular phone; an electronic notepad, a laptop, and/or a personal computer; a personal digital assistant (PDA) including a telephone; a gaming device or console; a music playing device; a Global Positioning System (GPS) device; a digital camera; or another type of computational or communication device.

As shown in FIG. 2, device 200 may include a speaker 202, a display 204, control buttons 206, a keypad 208, a microphone 210, and a housing 216. Speaker 202 may provide audible information to a user of device 200. Display 204 may provide visual information to the user, such as the image of a caller, text, video images, or pictures. Control buttons 206 may permit the user to interact with device 200 to cause device 200 to perform one or more operations, such as place or receive a telephone call. Keypad 208 may include a telephone keypad. Microphone 210 may receive sound, e.g., the user voice during a telephone call.

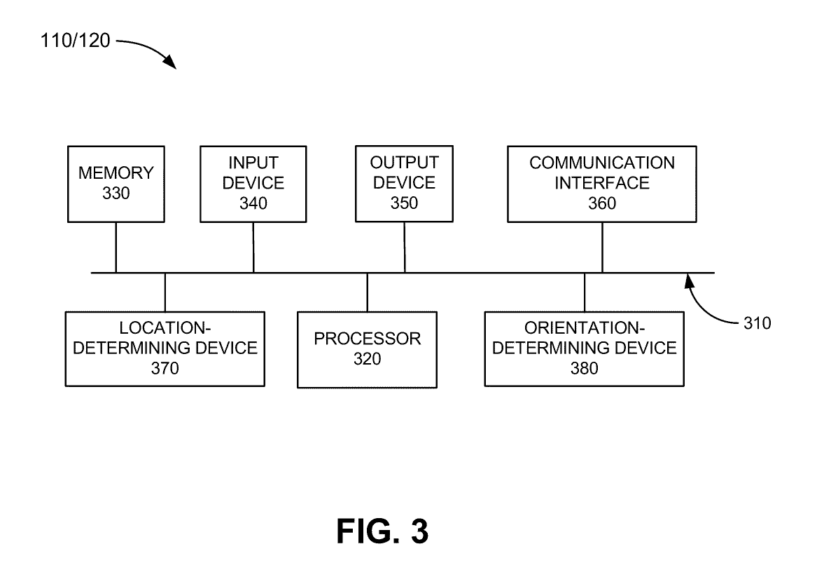

FIG. 3 is a block diagram of exemplary components of a mobile device 300. Mobile device 300 may correspond to either of user devices 110 or 120. As illustrated, mobile device 300 may include a bus 310, a processor 320, a memory 330, an input device 340, an output device 350, a communication interface 360, a location determining device 370, and an orientation determining device 380. Mobile device 300 may include other components (not shown) that aid in receiving, transmitting, and/or processing data. Moreover, other configurations of components in mobile device 300 are possible.

Bus 310 may include a path that permits communication among the components of mobile device 300. Processor 320 may include a processor, microprocessor, an application specific integrated circuit (ASIC), field programmable gate array (FPGA) or other processing logic. Processor 320 may execute software instructions/programs or data structures to control operation of device 300.

Memory 330 may include a random access memory (RAM) or another type of dynamic storage device that stores information and instructions, e.g., an application, for execution by processor 320; a read only memory (ROM) or another type of static storage device that stores static information and instructions for use by processor 320; a flash memory (e.g., an electrically erasable programmable read only memory (EEPROM)) device for storing information and instructions; and/or some other type of magnetic or optical recording medium and its corresponding drive. Memory 330 may also be used to store temporary variables or other intermediate information during execution of instructions by processor 320. Instructions used by processor 320 may also, or alternatively, be stored in another type of computer-readable medium accessible by processor 320. A computer-readable medium may include one or more memory devices.

Input device 340 may include any mechanism that permits an operator to input information to mobile device 110/120, such as a keypad, a microphone, a keyboard, a mouse, a pen, voice recognition mechanisms, a visual gesture interpreting engine (incorporating, for example, a gyroscope, an accelerometer, etc), a global positioning satellite (GPS) receiver, etc. Input device 240 may also include one or more buttons that allow a user to receive a menu of options via output device 250. The menu may allow the user to select various functions or modes associated with applications executed by processor 220.

Output device 250 may include one or more mechanisms that output information to the user, one or more speakers, an audio or audio visual interface (e.g., HDMI (high-definition multimedia interface), DVI (digital video interface), composite video, analog/digital audio, and/or component video interfaces), a display, such as an LCD (liquid crystal display), plasma, or LED (light emitting diode) display, a printer, a wired or wireless headset (e.g., a Bluetooth® headset), etc.

Communication interface 360 may include a transceiver that enables mobile device 110/120 to communication with other devices and/or systems, e.g., via network 130. For example, communication interface 360 may include other mechanisms for communicating via a network, such as a wireless network. For example, communication interface 360 may include one or more radio frequency (RF) transmitters, receivers, and/or transceivers for communicating via a wireless (e.g., Wi-Fi) or cellular network. Alternatively, communication interface 360 may include a modem or an Ethernet interface to a LAN.

In other implementations, communication interface 360 may include components for transmitting and receiving analog and/or digital telecommunications signals, such as GSM (global system for mobile communications), PCS (personal communication services), FDMA (frequency division multiple access), CDMA (code division multiple access), TDMA (time division multiple access), GPRS (General Packet Radio Service), EDGE (Enhanced Data Rates for GSM Evolution), and/or HSDPA (high speed downlink packet access) signals. Additionally, communication interface 360 may include components for transmitting and receiving short-range radio frequency (RF) signals associated with local network 130 (e.g., Bluetooth®, Wi-Fi (e.g., IEEE 802.11x), or WiMAX (e.g., IEEE 802.16x) networks). For example, communication interface 360 may output audio signals to a Bluetooth® or Wi-Fi connected accessory or headset.

Location-determining device 370 may include a GPS receiver (e.g., a chipset) for receiving signals from orbiting satellites or stationary towers for use in determining the position of mobile device 110/120. Orientation-determining device 380 may include a device for determining an orientation of device 300 relative to a known parameter. An exemplary orientation-determining device 380 may include a digital compass, often referred to as a magnetometer. A magnetometer includes any device capable of measuring the strength of a magnetic field. The output of the magnetometer may be used to accurately determine the orientation of device 300 relative to a particular location, such as the direction North.

In another implementation, orientation-determining device 380 may include one or more motion-sensing devices, such as accelerometers and/or gyroscopes, for accurately translating movement of device 300 into orientation information.

Consistent with implementations described herein mobile devices 110/120 may provide a platform that enables users of these devices to easily and rapidly exchange information via network 130. More specifically, mobile devices 110/120 may be configured to use location and orientation information of the mobile devices to initiate and accept one or more data files or items of information.

Mobile devices 110 and 120 may perform these operations in response to processor 220 (in user devices 110 and 120) executing sequences of instructions contained in a computer-readable medium, such as memory 230. Such instructions may be read into memory 230 from another computer-readable medium via, for example, communication interface 360. A computer-readable medium may include one or more memory devices. In alternative embodiments, hard-wired circuitry may be used in place of or in combination with software instructions to implement processes consistent with the invention. Thus, implementations described herein are not limited to any specific combination of hardware circuitry and software.

Although the embodiments provided herein are described in terms of a single sending mobile device (e.g., mobile device 110) and a single receiving mobile device (e.g., mobile device 120), implementations consistent with this description may be provided by any suitable number of devices, including multiple receiving devices.

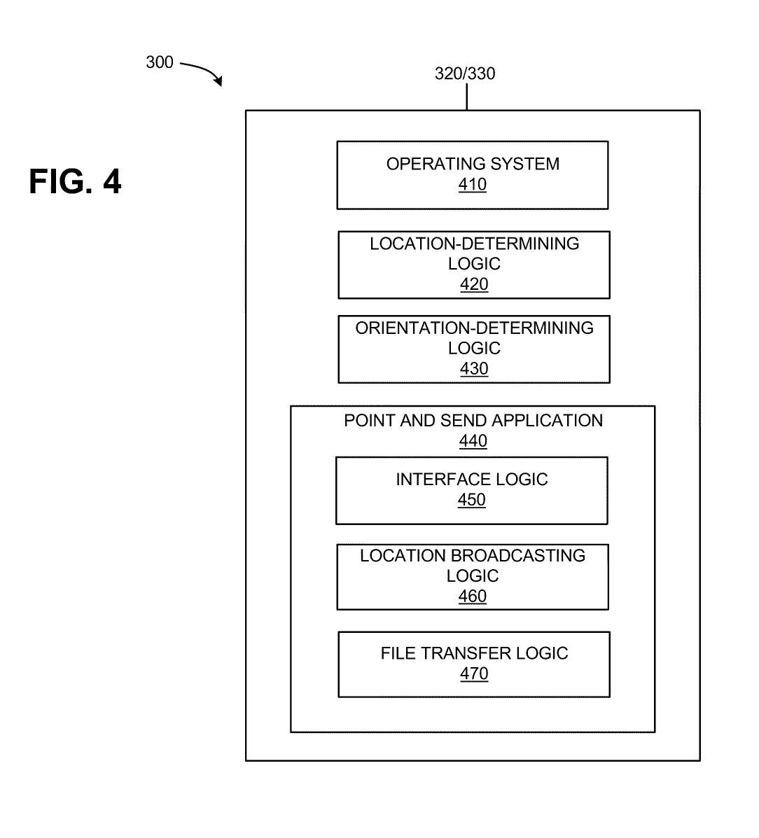

FIG. 4 illustrates one implementation of an exemplary functional block diagram of components implemented in mobile device 300. The logical blocks illustrated in FIG. 4 may be implemented in software, hardware, a combination of hardware and software. In one exemplary implementation, the logical blocks illustrated in FIG. 4 may be included in memory 330 in mobile device 300.

Referring to FIG. 4, memory 330 of mobile device 300 may include an operating system 410, location-determining logic 420, orientation-determining logic 430, and a point and send application 440. Point-and-send application 440 may include interface logic 450, location broadcasting logic 460, and file transfer logic 470. For the purposes of this description a source device may be referred to as mobile device 300-1 and a destination device may be referred to as mobile device 300-2. Where both the source and destination devices are implicated, the general numeral 300 may be used.

Operating system 410 may include software instructions for managing hardware and software resources of mobile device 300. Operating system 410 may manage, for example, its file system, device drivers, communication resources (e.g., radio receiver(s), transmission control protocol (TCP)/IP stack), event notifications, etc. Operating system 410 may include Symbian, Android, Windows Mobile, etc.

Location-determining logic 420 may include an application, such as a GPS or WiFi location determining application that interacts with location-determining device 370 to determine the geographic location of mobile device 300. In one implementation, location-determining logic 420 may store the identified geographic location in a portion of memory 330 available to other components of device 300, such as point-and-send application 440.

Orientation-determining logic 420 may include an application, such as a compass application, that interacts with orientation-determining device 380 to determine an orientation direction of mobile device 300. In one implementation, the orientation direction may include a predetermined level of detail, such as particular angle relative to magnetic North.

Point-and-send application 440 may include logic configured to interact with a user to identify and transmit/receive information in the manner described herein. Interface logic 450 may include logic configured to provide a user with an interface or collection of interfaces associated with point-and-send application 440. For example, interface logic 450 may provide a contextual menu selection available in a number of applications on mobile device 300, such as media applications, an address book application, a browser application, etc. In other implementations, interface logic 440 may provide a file browsing interface that allows a user to select a file (or files) for transfer from among a number of available files. Regardless of the manner in which files are presented to the user, interface logic 450 may be configured to receive a user selection of a particular file or number of files for transfer by file transfer logic 470.

Interface logic 450 may be further configured to output notifications to a user upon transmission and/or receipt of a file transfer request from another mobile device 300. For example, interface logic 450 may be configured to output a visible notification via display 204, or an audible notification via speaker 202 indicating that a file transfer request has been sent and/or received. In other implementations, interface logic 450 may provide the notification via a haptic output via a vibrator mechanism (not shown) associated with mobile device 300.

Location broadcasting logic 460 may include logic configured to output, e.g., via communication interface 360, identification information for device 300 (e.g., a hostname, device name (e.g., Bluetooth® device name), or Internet Protocol (IP) address associated with device 300) and information indicative of the geographic location of device 300 (e.g., longitude and latitude, etc.). For example, location broadcasting logic 460 may retrieve the geographic location identified by location-determining logic 420. In one implementation, the geographic location and identification information may be transmitted to an external device or service, such as a location-based web service (e.g., Google™ Latitude). In other implementations, the geographic location and identification information may be broadcast or periodically transmitted to other devices proximate to device 300. For example, location broadcasting logic 460 may transmit the geographic location and identification information to devices within Bluetooth® range, or devices connected to a common WiFi network (e.g., network 130). In this manner, mobile devices 300 may be made aware of a geographic location and corresponding identity of other mobile devices.

File transfer logic 470 may include logic configured to exchange files or information with another mobile device based on location and orientation information associated with source device 300-1 (e.g., mobile device 110) and destination device 300-2 (e.g., mobile device 120). For example, file transfer logic 470 in mobile device 300-1 may be configured to receive an indication of a file for transferring to destination device 300-2, e.g., from interface logic 450.

File transfer logic 470 may identify the geographic locations and corresponding identities of nearby devices (e.g., from a location-based web service or via location broadcast messages from the respective devices). In some implementations, nearby devices may include devices connected to network 130 and located within a predetermined distance (e.g., 100 yards) of source mobile device 300-1.

File transfer logic 470 may identify a user selection of a particular destination device 300-2 (e.g., mobile device 120) based on the geographic location information from location-determining logic 420, the orientation information from orientation-determining logic 430 (e.g., the direction in which mobile device 110 is being pointed), and the geographic location of the available destination devices. For example, file transfer logic 470 may determine a pointing line associated with source mobile device 300-1 based on the geographic location of source mobile device 300-1 and the orientation information. File transfer logic 470 may then identify a destination device that is within a predetermined range of the pointing line.

In one implementation, a tolerance level associated with this determination may be dynamically adjusted based on a distance between source mobile device 300-1 and destination mobile device 300-2. For example, the tolerance level (e.g., the proximity within which the destination device must be to the pointing line) may increase proportionately with the distance between the devices, with devices farther apart from each other having a higher tolerance level than devices closer to each other. This follows from the fact that small changes in orientation angles may be magnified as the distance between two devices increases. Furthermore, it may be more difficult to accurately “aim” the source device at the destination device as the distance between the two devices increases.

File transfer logic 470 may transmit a file transfer request to the identified destination device 300-2 via network 130 based on the identification information associated with destination device 300-2 (e.g., as broadcast by location broadcasting logic 460 in destination device 300-2). In one implementation, the file transfer request may include an identity of source mobile device 300-1, a geographic location of the source mobile device 300 (e.g., a longitude and latitude), and orientation information associated with source mobile device 300-1 (e.g., an angle relative to magnetic North). In some implementations, the file transfer request may also include information regarding the file to be transferred.

In response to a receipt of a file transfer request from source mobile device 300-1, file transfer logic 470 in destination mobile device 300-2 may notify the user via interface logic 450. For example, interface logic 450 may provide an audible, visual, or haptic notification to the user of destination mobile device 300-2 indicating that source mobile device wishes to send it a file. In some implementations, the notification may include identification information corresponding to source mobile device 300-1, such as a device name, a name of the user of the device, etc. In additional implementations, the notification may provide an indication of a geographic location of source mobile device 300-1, e.g., by providing an arrow or other indicia.

Assuming that the destination mobile device 300-2 wishes to receive the file, the user of that device may point destination device 300-2 towards source device 300-1. File transfer logic 470 in destination mobile device 300-2 may determine when its orientation angle (as determined by orientation-determining logic 420) matches an inverse (e.g., offset by 180 degrees) of the orientation information received in the file transfer request. This indicates that the two devices are pointing at each other.

When this occurs, file transfer logic 470 in destination mobile device 300-2 may transmit a file transfer acknowledgement to source mobile device 300-1 via network 130. The file transfer acknowledgement may include the identity of destination mobile device 300-2, the geographic location of the destination mobile device 300-2, and the orientation information associated with destination mobile device 300-2.

In response to the file transfer acknowledgement, file transfer logic 470 in source mobile device 300-1 may compare the received orientation information to its own orientation information. If the two orientations are inverses of each other (e.g., the devices are pointed at one another), the file may be transmitted to destination mobile device 300-2.

In some implementations, source device 300-1 may transmit a stream of data (e.g., an audio or video stream) to destination device 300-2 rather than a discrete file or item of information. In this information, the identified pointing conditions of each device 300-1 and 300-2 may be used to determine the duration of the streaming session such that source device 300-1 only streams data to destination device 300-2, while the devices are pointed at one another.

In one exemplary implementation, orientation information of the source or destination device may be used to encrypt the file. For example, file transfer logic 470 in source mobile device 300-1 may generate an encryption key based on its orientation information. The selected file may be encrypted using the generated key and transmitted to destination mobile device 300-2.

Upon receipt at destination mobile device 300-2, file transfer logic 470 in destination mobile device 300-2 may generate a decryption key based on an inverse of its orientation information. When source mobile device 300-1 and destination mobile device 300-2 are pointed at one another, the inverse of the orientation information of destination mobile device 300-2 may be equal to the orientation information of source mobile device 300-1. The generated decryption key may be used to decrypt the received file. Because only devices pointing at each other are able to determine their respective orientation information, the file transfer may be secured.

### Exemplary Processing

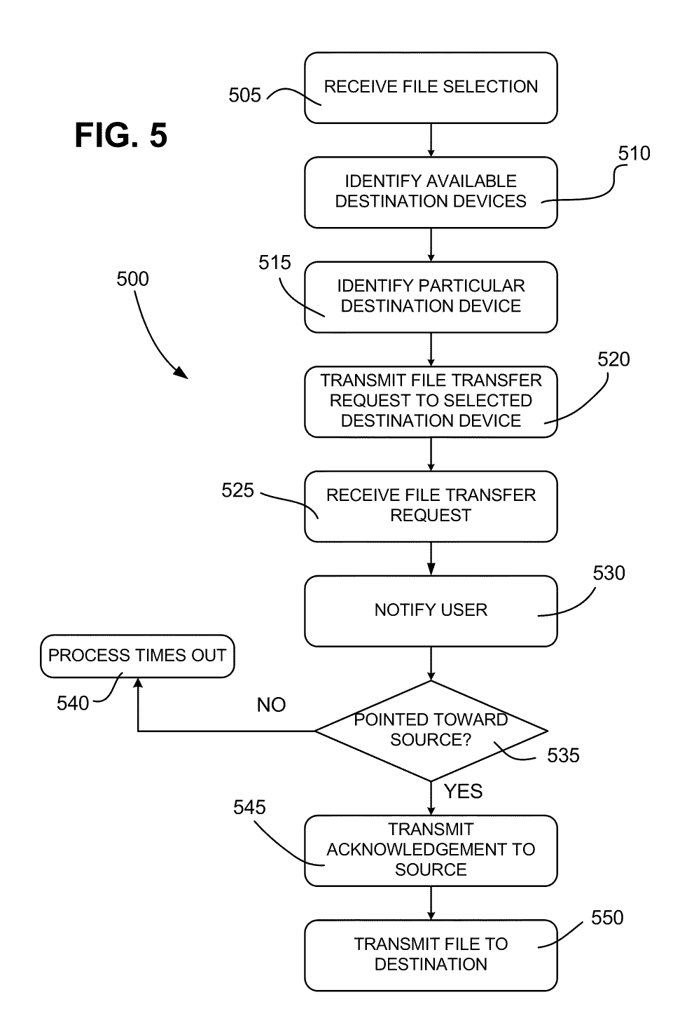

FIG. 5 is a flowchart of an exemplary process 500 for transmitting a file from a source device to a destination device in a manner consistent with implementations described herein. Process 500 may begin with the source device receives a user selection of a particular file or item of information to transfer (block 505). For example, interface logic 450 may receive the file selection via a contextual menu associated with a file browsing application. In other implementations, interface logic 450 may receive the file selection via a stand-alone point-and-send application.

The source device may identify available destination devices (block 510). For example, file transfer logic 470 may identify devices that have made their location information available within a predetermined vicinity of the source device (e.g., 100-500 yards). As described above, location broadcasting logic 460 in destination devices (as well as the source device) may periodically provide location and identification information to other devices. In one implementation, the location and identification information may be made available locally via network 130. Alternatively, the location and identification information may be provided via a location-based service or location-related web site.

Exemplary location and identification information may include a name/address (e.g., IP address) of the device (or the user of the device) and a longitude and latitude associated with the device's geographic location. The longitude and latitude information may be based on a location determined by location-determining logic 420 at the destination devices.

The source device may identify a particular destination device for transferring the file to based on the location information associated with the selected destination device, the geographic location of the source device, and the orientation of the source device (block 515). For example, file transfer logic 470 may retrieve location and orientation information for the source device from location-determining logic 420 and orientation-determining logic 430, respectively. Based on this information, file transfer logic 470 may determine a pointing line corresponding to a direction in which the source device is pointing and a distance to the destination device. File transfer logic 470 may then identify an available destination device located at or near the location corresponding to the determined pointing line based on the location information received about the available destination devices. In one implementation, the user of the source device may be notified regarding selection of a destination device, e.g., via an audible, visual, or haptic notification. This may help a user to determine when they are accurately pointing at the desired destination device.

In one implementation, ambiguities relating to more than one available device falling within a predetermined distance of the pointing line may be resolved based on relative proximities of the available destination devices to the user. For example, a closest destination device may be selected. If both devices are substantially equidistant from the source device, interface logic 450 may query the user about which device to select.

In another implementation, ambiguities relating to more than one available device falling within a predetermined distance of the pointing line may be resolved based on contact information stored on the source device. For example, when deciding between two proximal destination devices, file transfer logic 470 may determine a number of prior communications that have been exchanged with either device. File transfer logic 470 may select the destination device with which the source device has exchanged a higher number of communications. For example, file transfer logic 470 may determine that the source device has exchanged 4 phone calls, 25 text messages, and 5 emails with the contact associated with the first available destination device, and only a single phone call from the contact associated with the second available destination device. In this example, file transfer logic 470 may select the first available destination device.

Furthermore, in some implementations, a tolerance level associated with determining whether a destination device is within range of the pointing line may be dynamically determined based on a distance between the source device and the available destination devices. For example, a point on the pointing line 200 yards away from the source device may have a higher tolerance level (e.g., destination devices farther away from the line may be considered to be in range) than a point on the pointing line 10 yards away from the source device. This allows for reduced accuracy when pointing at devices a farther distance away from the source device.

Source device may transmit a file transfer request to the selected destination device (block 520). For example, file transfer logic 470 may transmit the transfer request based on the identification information (e.g., IP address) corresponding to the selected destination device via network 130. In one implementation, the file transfer request may include identification information (e.g., source IP address, device name, etc.), geographic location information, and orientation information for the source device. The file transfer request may be transmitted upon receipt of a user command via interface logic 450.

The destination device may receive the file transfer request from the source device (block 525) and may notify the user of the destination device that the file transfer request has been received (block 530). In one implementation, interface logic 450 in the destination device may provide an audible, visual, or haptic notification to the user. The notification may include a name of the source device (or a user of the source device) and an indication relating to the relative geographic location of the source device.

The destination device may determine whether the destination device is pointed toward the source device (block 535). For example, file transfer logic 470 in the destination device may compare the orientation of the destination device to the received orientation information for the source device. In one implementation, destination device may make this determination periodically within a predetermined timeout period. If the user of the destination device does not wish to receive the file, the user may not point the destination device toward the source device within the timeout period (e.g., 30 seconds). This may cause the file transfer process to time out on both the source device and the destination device (block 540).

However, if the destination device is pointed toward the source device (e.g., the orientation of the destination device substantially equals an inverse of the orientation of the source device (e.g., offset by approximately 180 degrees)), the destination device may transmit a file transfer acknowledgement to the source device (block 545). For example, file transfer logic 470 in the destination device may transfer a message to the source device based on the device identification information received in the file transfer request. The message may include the orientation information for the destination device.

In another exemplary implementation, the destination device may not be pointed back toward the source device, but may instead transmit a file transfer acknowledgement to the source device upon receipt of a user command, such as the pressing of a button, a motion gesture, a voice command, etc. In this manner, the user of the destination device may accept the file transfer without the need to re-orient his/her phone. In some implementations, both a pointing-based a file transfer acknowledgement and a command-based transmit a file transfer acknowledgement may be implemented, thereby giving the user a choice in how to respond.

In response to the received file transfer acknowledgement, the source device may transmit the selected file or item of information to the destination device, based on the identification information (e.g. IP address) associated with the destination device (block 550). In one implementation, the file may be transmitted to another device associated with the user of the destination device, such as an email address, an online file storage location, a third party, etc. This may be set up in a point-and-send profile associated with the destination device. For example, user established preferences or profile information associated with point-and-send application 440 may indicate a destination for a transferred file. The preferences or profile may be stored, for example, in memory 330.

In other implementations consistent with aspects described herein, the source device may not transfer a file directly from the source device to the destination device following an identified pointing orientation. Instead, an identified pointing may cause a third party or other entity to perform an action or function, such as a financial transaction, etc.

In still other implementations, an identified pointing orientation may cause the destination device to perform a defined function or action, either alone or in combination with other actions. For example, the destination device may be a door, and upon identification that the source device is pointing to the door, the door may be opened or unlocked.

As described above, in one implementation, the orientation information associated with the source/destination device may be used to encrypt/decrypt the transferred file, thereby preventing unauthorized parties from successfully opening/using the file or information. For example, the file may be encrypted using the orientation of the destination device. The file may be decrypted by the destination device using the same information.

### CONCLUSION

The foregoing description of implementations provides illustration, but is not intended to be exhaustive or to limit the implementations to the precise form disclosed. Modifications and variations are possible in light of the above teachings or may be acquired from practice of the teachings.

For example, while series of blocks have been described with regard to the exemplary process illustrated in FIG. 5, the order of the blocks may be modified in other implementations. In addition, non-dependent blocks may represent acts that can be performed in parallel to other blocks.

Aspects described herein may be implemented in many different forms of software, firmware, and hardware in the implementations illustrated in the figures. The actual software code or specialized control hardware used to implement aspects does not limit the invention. Thus, the operation and behavior of the aspects were described without reference to the specific software code—it being understood that software and control hardware can be designed to implement the aspects based on the description herein.

The term “comprises/comprising,” as used herein, specifies the presence of stated features, integers, steps or components but does not preclude the presence or addition of one or more other features, integers, steps, components, or groups thereof.

Further, certain portions of the implementations have been described as “logic” that performs one or more functions. This logic may include hardware, such as a processor, a microprocessor, an application specific integrated circuit, or a field programmable gate array, software, or a combination of hardware and software.

No element, act, or instruction used in the present application should be construed as critical or essential to the implementations described herein unless explicitly described as such. Also, as used herein, the article “a” is intended to include one or more items. Further, the phrase “based on” is intended to mean “based, at least in part, on” unless explicitly stated otherwise.

What is claimed is:

1. A method comprising:
identifying a selected file recipient device based on a location of the file recipient device, a location of a file transmitting device, and an orientation of a file transmitting device;
transmitting a file transfer request to the selected file recipient device;
receiving an acknowledgement from the selected file recipient device based on the orientation of the selected file recipient device being approximately 180 degrees offset from the orientation of the file transmitting device; and
transmitting a selected file to the file recipient device following receipt of the acknowledgement.

2. The method of claim 1, wherein identifying the selected file recipient device comprises:
identifying a number of available file recipient devices;
determining, a geographic locations of the number of available file recipient devices;
determining the orientation of the file transmitting device;
determining a geographic location of the file transmitting device; and
identifying the selected file recipient device based on the geographic locations of the number of available file recipient devices, the geographic location of a file transmitting device, and an orientation of the file transmitting device.

3. The method of claim 2, further comprising:
generating a pointing line based on the geographic location and the orientation of the file transmitting device;
determining whether at least one of the number of available file recipient devices is within a predetermined distance of a location on the pointing line based on the geographic locations of the number of available file recipient devices; and
identifying the selected file recipient device when the selected file recipient device is within the predetermined distance of the location on the pointing line.

4. The method of claim 3, further comprising:
identifying the selected file recipient device as the closest of a second number of available file recipient devices located within the predetermined distance of the location on the pointing line.

5. The method of claim 3, wherein the predetermined distance of the location on the pointing line is based on a distance from the file transmitting device.

6. The method of claim 3, wherein the predetermined distance of the location on the pointing line is based on a tolerance value associated with locations on the pointing line.

7. The method of claim 1, wherein the file transfer request includes the orientation of the file transmitting device.

8. The method of claim 7, wherein the acknowledgement includes the orientation of the file recipient device.

9. The method of claim 8, wherein transmitting the selected file to the file recipient device comprises:
comparing the orientation of the file recipient device with the orientation of the file transmitting device; and
transmitting the selected file to the file recipient device when the orientation of the file recipient device substantially matches an angle 180 degrees offset from the orientation of the file transmitting device.

10. The method of claim 8, further comprising:
encrypting the selected filed based on the orientation of the file recipient device, wherein the selected file is decrypted by the file recipient device based on the orientation of the file recipient device.

11. The method of claim 1, further comprising:
generating an audible, visual, or haptic notification at the file transmitting device when the file transmitting device is pointed at one of the number of available file recipient devices.

12. A method, comprising:
providing identification and geographic location information for a destination device to a source device via a network;
receiving a file transfer request that includes a geographic location of the source device, and an orientation of the source device via the network;
determining whether an orientation of the destination device substantially matches an angle 180 degrees offset from the orientation of the source device;
transmitting a file transfer acknowledgement to the source device via the network when an orientation of the destination device substantially matches an angle 180 degrees offset from the orientation of the source device; and
receiving a selected file from the source device via the network.

13. The method of claim 12, wherein providing identification and geographic location information for a destination device comprises transmitting the identification and geographic location information to a location-aware service.

14. The method of claim 12, wherein providing identification and geographic location information for a destination device comprises transmitting the identification and geographic location information to devices connected to the network, wherein the network comprises a local wireless network.

15. The method of claim 12, further comprising:
generating an audible, visual, or haptic notification upon receipt of the file transfer request.

16. The method of claim 15, wherein the notification indicates a direction of the source device.

17. The method of claim 12, wherein the file transfer acknowledgement includes the orientation of the destination device.

18. The method of claim 12, wherein the selected file comprises an encrypted file, the method further comprising:
decrypting the selected file based on the orientation of the destination device.

19. A mobile device comprising:
a communication interface to receive geographic location and identification information associated with a number of destination devices via a computer network;
a location-determining device to determine a geographic location of the mobile device;
an orientation-determining device to determine an orientation of the mobile device; and
a processor to:
receive a user selection of a file;
identify a selected destination device from the number of destination devices based on the geographic location of the destination devices, the location of the mobile device, and the orientation of the mobile device;
transmit a file transfer request to the selected destination device via the communication interface;
receive an acknowledgement from the selected destination device based on the orientation of the selected destination device being approximately 180 degrees offset from the orientation of the mobile device; and
transmit the selected file to the destination device via the communication interface following receipt of the acknowledgement.

20. The mobile device of claim 19, wherein the processor is further configured to:
encrypt the selected file based on the orientation of the selected destination device; and
transmit the encrypted file to the selected destination device via the communication interface.
